(19) United States
(12) Patent Application Publication
(10) Pub. No.: US 2016/0190911 A1
(43) Pub. Date: Jun. 30, 2016

(54) OVERHEATING CONTROL APPARATUS AND DRIVING SYSTEM USING THE SAME

(71) Applicant: SAMSUNG ELECTRO-MECHANICS CO., LTD., Suwon-si (KR)

(72) Inventor: Soo Woong LEE, Suwon-si (KR)

(73) Assignee: SAMSUNG ELECTRO-MECHANICS CO., LTD., Suwon-si (KR)

(21) Appl. No.: 14/954,286

(22) Filed: Nov. 30, 2015

(30) Foreign Application Priority Data
Dec. 26, 2014 (KR) 10-2014-0190660

(51) Int. Cl. H02M 1/32

(52) U.S. Cl. CPC H02M 1/32; H02M 2001/327; H02M 2001/325

(57) ABSTRACT

An overheating control apparatus according to examples includes an overheating detector configured to detect an overheating state, and a driving controller configured to provide a driving signal to driving circuits, and to change a duty ratio of the driving signal provided to at least a portion of the driving circuits according to the overheating state. In this manner, the overheating control apparatus helps manage problems that would otherwise occur due to overheating.

### CROSS-REFERENCE TO RELATED APPLICATION(S)

This application claims the benefit under 35 USC 119(a) of Korean Patent Application No. 10-2014-0190660 filed on Dec. 26, 2014 in the Korean Intellectual Property Office, the entire disclosure of which is incorporated herein by reference for all purposes.

### BACKGROUND

1. Field

The following description relates to an overheating control apparatus. The following description also relates to a driving system using the overheating control apparatus.

2. Description of Related Art

Electronic devices may include various elements, and such elements generate heat when driven as waste heat that occurs due to inefficiency inherent to electrical flow.

When the generated heat or heat based on a peripheral device or an environment is absorbed, performance and/or stability of electronic devices is degraded, requiring a technique for preventing overheating and resulting defective operation.

When overheating is detected, alternative approaches that provide overheating preventing techniques handle overheating by stopping an operation of an overall driving circuit. However, since an overall system may be excessively shut down due to overheating for a short time, stability and performance of the system are potentially adversely affected by such alternative art overheating preventing techniques.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present examples provides an overheating control apparatus that is capable of providing a stable output even in a state in which overheating occurs, and a driving system using such an overheating control apparatus.

In one general aspect, an overheating control apparatus includes an overheating detector configured to detect an overheating state, and a driving controller configured to provide a driving signal to driving circuits, and to change a duty ratio of the driving signal provided to at least a portion of the driving circuits according to the overheating state.

The overheating detecting unit may include a reference voltage generator configured to provide a reference voltage irrespective of a change in temperature, a comparison voltage generator configured to provide a comparison voltage affected by a change in temperature, and a hysteresis comparator configured to hysteresis-compare the reference voltage and the comparison voltage.

The comparison voltage generator may include a complementary-to-absolute-temperature (CTAT) voltage source configured to generate a voltage in inverse proportion to temperature.

The driving controller may lower a duty ratio of the driving signal provided to the at least a portion of driving circuits, in response to overheating occurring, and may set the duty ratio of the driving signal provided to the at least a portion of the driving circuits to 1, in response to overheating not occurring.

The driving controller may classify the driving circuits into a first driving circuit group and a second driving circuit group, and may change a duty ratio of a driving signal applied to the first driving circuit group according to whether overheating occurs.

The driving controller may maintain a duty ratio of a driving signal applied to the second driving circuit group, regardless of the overheating state.

In response to overheating occurring, the driving controller may set the duty ratio of the driving signal provided to the second driving circuit group to 1.

In response to overheating occurring, the driving controller may lower the duty ratio of the driving signal provided to the first driving circuit group.

In another general aspect, a driving system includes a driving circuit apparatus including driving circuits, and an overheating preventor configured to detect an overheating state, and to change a duty ratio of a driving signal provided to at least a portion of the driving circuits in response to the overheating state being detected.

The overheating preventor may include an overheating detector configured to detect the overheating state, and a driving controller configured to provide a driving signal to the driving circuits, and to change the duty ratio of the driving signal provided to the at least a portion of the driving circuits according to whether overheating occurs.

The overheating detecting unit may include a reference voltage generator configured to provide a reference voltage irrespective of a change in temperature, a comparison voltage generator configured to provide a comparison voltage affected by a change in temperature, and a hysteresis comparator configured to hysteresis-compare the reference voltage and the comparison voltage.

The comparison voltage generator may include a complementary-to-absolute-temperature (CTAT) voltage source configured to generate a voltage in inverse proportion to temperature.

The driving controller may lower the duty ratio of the driving signal provided to the at least a portion of the driving circuits, in response to the overheating occurring, and may set the duty ratio of the driving signal provided to the at least a portion of the driving circuits to 1, in response to overheating not occurring.

The driving controller may classify the driving circuits into a first driving circuit group and a second driving circuit group, and may change a duty ratio of a driving signal applied to the first driving circuit group according to whether overheating occurs.

The driving controller may maintain a duty ratio of a driving signal applied to the second driving circuit group, regardless of whether overheating occurs, and may lower the duty ratio of the driving signal provided to the first driving circuit group, in response to overheating occurring.

In response to overheating occurring, the driving controller may set the duty ratio of the driving signal provided to the second driving circuit group to 1.

Other features and aspects will be apparent from the following detailed description, the drawings, and the claims.

### BRIEF DESCRIPTION OF THE DRAWINGS

FIG. 1 is a block diagram illustrating an overheating control apparatus according to an example.

FIG. 2 is a block diagram illustrating an overheating control apparatus according to another example.

FIG. 3 is a diagram illustrating a configuration of an example of an overheating detecting unit;

FIGS. 4 and 5 are reference graphs illustrating a hysteresis comparator of the overheating detecting unit illustrated in the example of FIG. 3.

FIG. 6 is a diagram illustrating a configuration of an example of a driving control unit.

FIG. 7 is a diagram illustrating a configuration of a driving system according to an example.

FIG. 8 is a diagram illustrating a configuration of a driving system according to another example.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, examples are described in further detail with reference to the accompanying drawings.

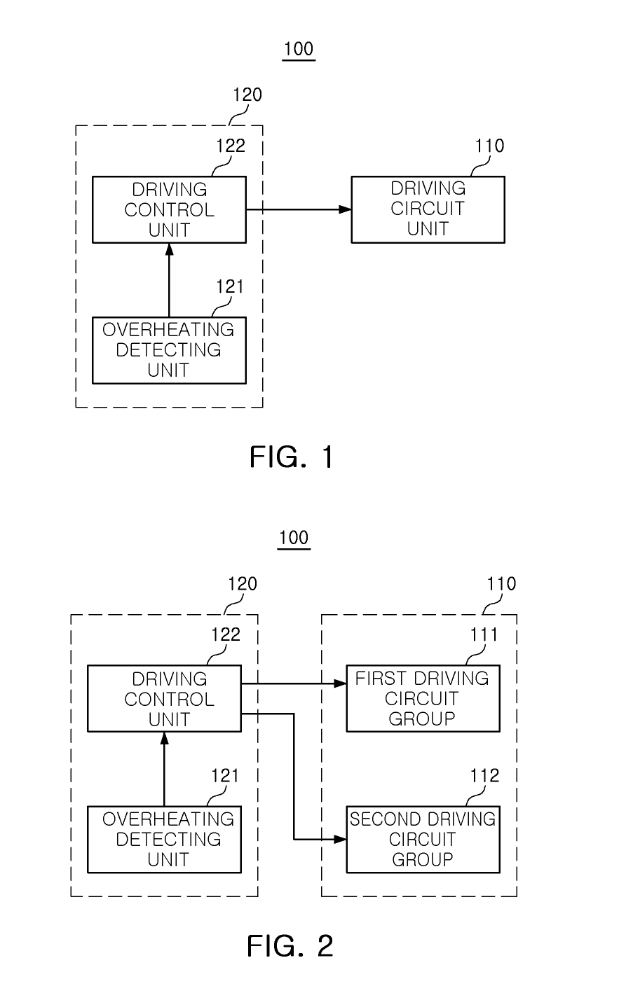

FIG. 1 is a block diagram illustrating an overheating control apparatus according to an example.

Referring to the example of FIG. 1, a driving system 100 includes an overheating control apparatus 120 and a driving circuit unit 110.

In this example, the driving circuit unit 110 includes a plurality of driving circuits.

The overheating control apparatus 120 provides a driving signal to the driving circuit unit 110. Also, the overheating control apparatus 120 changes the driving signal provided to the driving circuit unit 110 according to an overheating state.

For example, the overheating control apparatus 120 includes an overheating detecting unit 121 and a driving control unit 122.

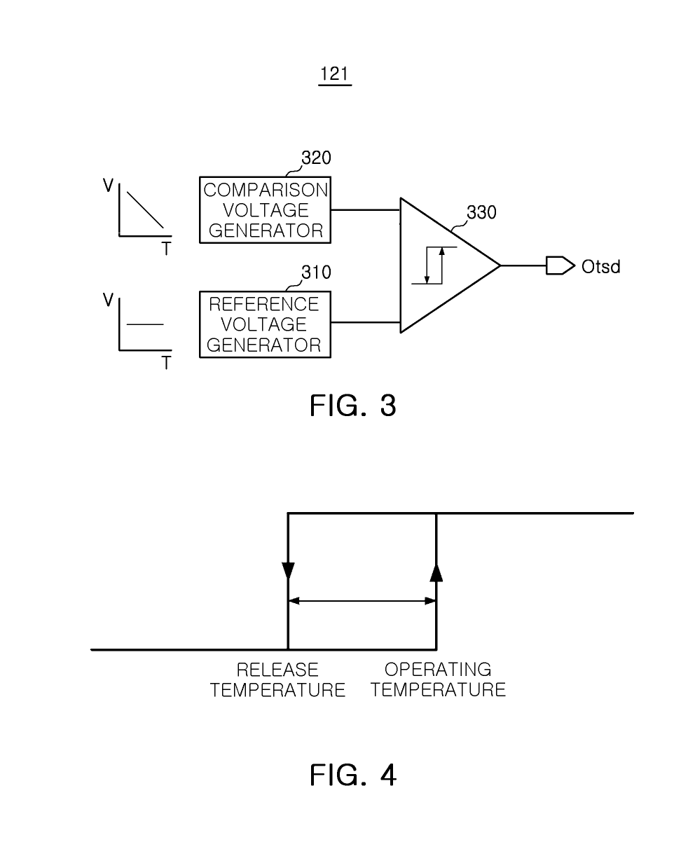

In this example, the overheating detecting unit 121 detects an overheating state. The overheating detecting unit determines an overheating state by applying hysteresis to a change in temperature. Hysteresis is the time-based dependence of a system's output on present and past inputs. The dependence arises because the history affects the values of an internal state. By using temperature information, therefore, it becomes possible to predict and model changes in temperature. Various examples of the overheating detecting unit are described in detail with reference to FIGS. 3 through 5.

The driving control unit 122 provides a driving signal to a plurality of driving circuits and changes a duty ratio of the driving signal provided to at least a portion of the plurality of driving circuits, according to an overheating state.

In an example, when overheating occurs, the driving control unit 122 lowers a duty ratio of the driving signal provided to at least a portion of the plurality of driving circuits. A duty ratio refers to a proportion of a period during which a signal is active.

In such an example, when overheating does not occur, the driving control unit 122 sets a duty ratio of the driving signal provided to at least a portion of the plurality of driving circuits to 1.

FIG. 2 is a block diagram illustrating an overheating control apparatus according to another example.

In the example illustrated in FIG. 2, the driving circuit unit 110 is classified as belonging to one of a plurality of groups.

In further detail, the driving control unit 122 classifies driving circuits of a plurality of driving circuits of the driving circuit unit 110 as each belonging to a first driving circuit group 111 or a second driving circuit group 112.

In an example, the driving control unit 122 changes a duty ratio of a driving signal for the first driving circuit group 111 according to whether overheating occurs. For example, when overheating occurs, the driving control unit 122 lowers a duty ratio of the driving signal provided to the first driving circuit group 111.

Also, in such an example, the driving control unit 122 provides a driving signal to the second driving circuit group 112, regardless of whether overheating has occurred. For instance, the driving control unit 122 maintains a duty ratio of the driving signal applied to the second driving circuit group 112, regardless of an overheating state. For example, the driving control unit 122 sets the duty ratio of the driving signal provided to the second driving circuit group 112 in the overheating state to be 1. Thus, in the present example, even in a scenario in which overheating occurs, the driving signal provided to the second driving circuit group 112 is not adjusted. In the present example, a driving circuit of the second driving circuit group 112 is an essential circuit that s required to be driven for overall functioning to continue, even in an overheating state or is alternatively a circuit that generates a small amount of heat or that consumes a small amount of power.

FIG. 3 is a diagram illustrating a configuration of an example of an overheating detecting unit.

Referring to FIG. 3, the overheating detecting unit 121 includes a reference voltage generator 310, a comparison voltage generator 320, and a hysteresis comparator 330.

The reference voltage generator 310 provides a reference voltage irrespective of a change in temperature.

The comparison voltage generator 320 provides a comparison voltage affected by a change in temperature.

In an example, the comparison voltage generator 320 includes a complementary-to-absolute-temperature (CTAT) voltage source that generates a voltage in inverse proportion to temperature.

In this example, the hysteresis comparator 330 hysteresis-compares the reference voltage and the comparison voltage.

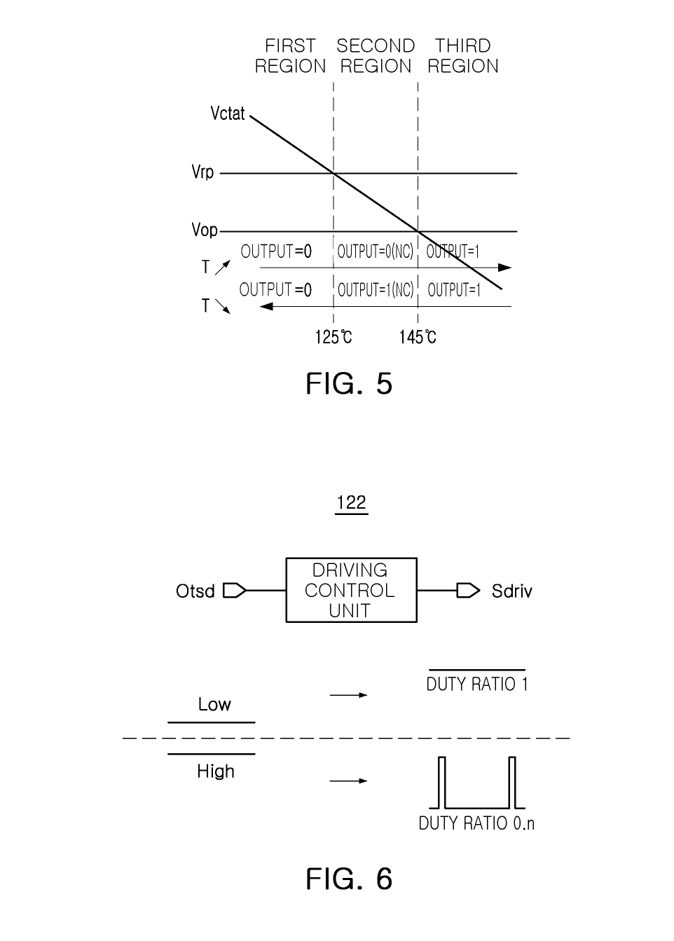

FIGS. 4 and 5 are reference graphs illustrating the results of the operation of the hysteresis comparator of the overheating detecting unit illustrated in FIG. 3. Hereinafter, an example of the overheating detecting unit 121 is described in further detail with reference to FIGS. 4 and 5.

With respect to the overheating detecting unit 121, FIG. 4 is a graph illustrating a hysteresis comparison.

As illustrated in FIG. 4, when a temperature increases to be equal to or higher than an operating temperature, the hysteresis comparator 330 outputs a high level signal. Thereafter, when the temperature decreases to be equal to or lower than a release temperature, the hysteresis comparator 330 outputs a low level signal. A difference between the operating temperature and the release temperature is used for hysteresis analysis.

FIG. 5 is a graph illustrating outputs of the hysteresis comparator 330 by region.

In the example of FIG. 5, it is observable that a comparison voltage Vctat is changed according to a change in temperature. The operating temperature Vop and the release temperature Vrp are values set using a reference voltage, and it is observable that the values are maintained, irrespective of temperature. In the illustrated example, the hysteresis value is present from 125° C. to 145° C., but the example of FIG. 5 is merely illustrative, and the hysteresis value is not limited thereto.

In the example of FIG. 5, region 2 corresponds to the hysteresis of FIG. 4, and it is observable that the results T of the hysteresis comparison values are changed with reference to the operating temperature Vop or the release temperature Vrp as temperature increases or decreases.

FIG. 6 is a diagram illustrating a configuration of an example of the driving control unit.

Referring to FIG. 6, upon receiving an output Otsd from the overheating detecting unit 121, the driving control unit 122 adjusts a duty ratio of a driving signal Sdriv.

When overheating occurs, the output Otsd from the overheating detecting unit has a high value, and when overheating does not occur, the output Otsd has a low value.

When the output Otsd from the overheating detecting unit 121 is low, the driving control unit 122 outputs the driving signal as is, without adjusting the duty ratio of the driving signal Sdriv. For example, the duty ratio of the driving signal in such a scenario is 1.

Meanwhile, when the output Otsd from the overheating detecting unit 121 is high, the driving control unit 122 adjusts a duty ratio of the driving signal Sdriv. Thus, the driving signal Sdriv output from the driving control unit 122 is output in a pulse waveform. According to the example, even in an overheating state, the driving circuit is driven for at least a partial amount of time, and thus, stability aspects of the system are improved.

In an example, the driving control unit 122 sets the duty ratio of the driving signal Sdriv differently according to the operation of a plurality of driving circuits or a driving circuit group. To this end, the driving control unit 122 maintains duty ratio data of each driving circuit or each driving circuit group.

In an example, the driving control unit 122 is realized as a control circuit or an integrated circuit. For example, the driving control unit 122 is implemented as a micro-controller unit (MCU), an integrated circuit (IC), or an application specific integrated circuit (ASIC).

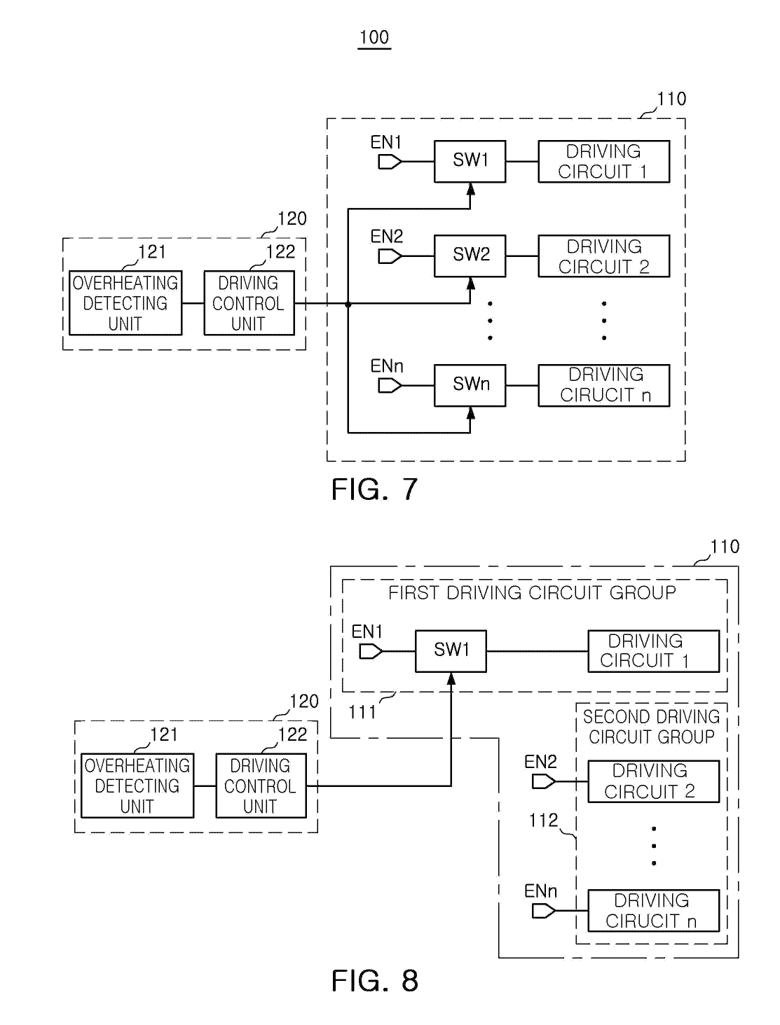

FIG. 7 is a diagram illustrating a configuration of a driving system according to an example.

As illustrated in the example of FIG. 7, a driving system 100 includes a driving circuit unit 110 and an overheating preventing unit 120. For example, the overheating preventing unit 120 corresponds to the overheating control apparatus described above further with reference to FIGS. 1 through 6.

For example, the driving circuit unit 110 includes a plurality of driving circuits.

In an example, the plurality of driving circuits include a switch in an input terminal corresponding to the driving circuits in the plurality of driving circuits, and the overheating preventing unit 120 adjusts a duty ratio of a driving signal applied to the plurality of driving circuits by adjusting the switch.

In an illustrative example, the switch receives an enable signal and provides the received enable signal or an enable signal modulated in a duty ratio to the driving circuits according to switching control performed by the overheating preventing unit 120.

According to an example, the switch directly receives an input signal from the overheating preventing unit 120.

FIG. 8 is a diagram illustrating a configuration of a driving system according to another example.

In the example of FIG. 8, an example in which driving circuit unit 100 of a driving system 100 is grouped in order to be driven is illustrated.

A first driving circuit group 111 receives a driving signal adjusted by the overheating preventing unit 120. For example, the overheating preventing unit 120 adjusts a switch SW1 to change a duty ratio of the driving signal applied to the first driving circuit group 111 when in an overheating state. In the illustrated example, a single driving circuit is disposed in the first driving circuit group 111, but this is example is merely illustrative and a plurality of driving circuits is provided in another example.

Meanwhile, a driving signal applied to the second driving circuit group 112 is not adjusted by the overheating preventing unit 120. For instance, as in the illustrated example, the overheating preventing unit 120 does not change a duty ratio of driving signals EN2 to ENn applied to the second driving circuit group 112.

In FIG. 8, the enable signals EN1 to ENn input from the outside are illustrated as being driving signals, but this is merely illustrative and the driving signals may be directly provided from the overheating preventing unit 120 as mentioned above.

As set forth above, according to examples, even in a state in which overheating occurs, a stable output is provided.

The apparatuses, units, modules, devices, and other components illustrated in FIGS. 1-8 that perform the operations described herein with respect to FIGS. 1-8 are implemented by hardware components. Examples of hardware components include controllers, sensors, generators, drivers, memories, comparators, arithmetic logic units, adders, subtractors, multipliers, dividers, integrators, and any other electronic components known to one of ordinary skill in the art. In one example, the hardware components are implemented by computing hardware, for example, by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-8. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described herein with respect to FIGS. 1-8 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMS, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An overheating control apparatus comprising:
an overheating detector configured to detect an overheating state; and
a driving controller configured to provide a driving signal to driving circuits, and to change a duty ratio of the driving signal provided to at least a portion of the driving circuits according to the overheating state.

2. The overheating control apparatus of claim 1, wherein the overheating detecting unit comprises:
a reference voltage generator configured to provide a reference voltage irrespective of a change in temperature;
a comparison voltage generator configured to provide a comparison voltage affected by a change in temperature; and
a hysteresis comparator configured to hysteresis-compare the reference voltage and the comparison voltage.

3. The overheating control apparatus of claim 2, wherein the comparison voltage generator comprises a complementary-to-absolute-temperature (CTAT) voltage source configured to generate a voltage in inverse proportion to temperature.

4. The overheating control apparatus of claim 1, wherein the driving controller lowers a duty ratio of the driving signal provided to the at least a portion of driving circuits, in response to overheating occurring, and
sets the duty ratio of the driving signal provided to the at least a portion of the driving circuits to 1, in response to overheating not occurring.

5. The overheating control apparatus of claim 1, wherein the driving controller classifies the driving circuits into a first driving circuit group and a second driving circuit group, and changes a duty ratio of a driving signal applied to the first driving circuit group according to whether overheating occurs.

6. The overheating control apparatus of claim 5, wherein the driving controller maintains a duty ratio of a driving signal applied to the second driving circuit group, regardless of the overheating state.

7. The overheating control apparatus of claim 6, wherein in response to overheating occurring, the driving controller sets the duty ratio of the driving signal provided to the second driving circuit group to 1.

8. The overheating control apparatus of claim 5, wherein in response to overheating occurring, the driving controller lowers the duty ratio of the driving signal provided to the first driving circuit group.

9. A driving system comprising:
a driving circuit apparatus comprising driving circuits; and
an overheating preventor configured to detect an overheating state, and to change a duty ratio of a driving signal provided to at least a portion of the driving circuits in response to the overheating state being detected.

10. The driving system of claim 9, wherein the overheating preventor comprises:
an overheating detector configured to detect the overheating state; and
a driving controller configured to provide a driving signal to the driving circuits, and to change the duty ratio of the driving signal provided to the at least a portion of the driving circuits according to whether overheating occurs.

11. The driving system of claim 10, wherein the overheating detecting unit comprises:
a reference voltage generator configured to provide a reference voltage irrespective of a change in temperature;
a comparison voltage generator configured to provide a comparison voltage affected by a change in temperature; and
a hysteresis comparator configured to hysteresis-compare the reference voltage and the comparison voltage.

12. The driving system of claim 11, wherein the comparison voltage generator comprises a complementary-to-absolute-temperature (CTAT) voltage source configured to generate a voltage in inverse proportion to temperature.

13. The driving system of claim 10, wherein the driving controller lowers the duty ratio of the driving signal provided to the at least a portion of the driving circuits, in response to the overheating occurring, and
sets the duty ratio of the driving signal provided to the at least a portion of the driving circuits to 1, in response to overheating not occurring.

14. The driving system of claim 10, wherein the driving controller classifies the driving circuits into a first driving circuit group and a second driving circuit group, and changes a duty ratio of a driving signal applied to the first driving circuit group according to whether overheating occurs.

15. The driving system of claim 10, wherein the driving controller maintains a duty ratio of a driving signal applied to the second driving circuit group, regardless of whether overheating occurs, and
lowers the duty ratio of the driving signal provided to the first driving circuit group, in response to overheating occurring.

16. The driving system of claim 15, wherein in response to overheating occurring, the driving controller sets the duty ratio of the driving signal provided to the second driving circuit group to 1.
